(19) United States
(12) Patent Application Publication
(10) Pub. No.: US 2002/0033851 A1
(43) Pub. Date: Mar. 21, 2002

(54) Process and apparatus for the printing of digital image information

(76) Inventors: Stephan Waldner, Zurich (CH); Armin Kundig, Zurich (CH); Guido Keller, Adlikon (CH); Fortunat Schrammli, Hausen (CH)

Correspondence Address: PENNIE AND EDMONDS, 1155 AVENUE OF THE AMERICAS, NEW YORK, NY, 100362711

(21) Appl. No.: 09/954,580

(22) Filed: Sep. 18, 2001

(30) Foreign Application Priority Data
Sep. 21, 2000 (EP) 00 120 155.7

(51) Int. Cl. B41J 29/38

(52) U.S. Cl. 347/5

(57) ABSTRACT

A remission sensor is provided in an inkjet printing apparatus for various measurement tasks, which sensor is constructed for densiometric and colorimetric measurement tasks and has a high local resolution. In a first application, the borders of the picture carrier are detected and the printing of pixels of the digital image located outside the borders prevented. This permits the manufacture of borderless pictures without the wasting of printing ink. In a second application, the sensor is used for the photoelectric scanning or measurement of co-printed print head test patterns. The functional condition of the print head(s) can be determined by analysis of the measurement data obtained with suitable algorithms, and corresponding measures can be initiated. In this way the production of waste can be prevented. In a further application, the sensor is also used for the measurement of co-printed color test patterns. Changes in the color reproduction quality can be recognized in time with measurement technology by analysis of the measurement data obtained and comparison thereof with corresponding reference values, and the changes can be corrected by suitable measures.

### FIELD OF THE INVENTION

The invention relates to processes and apparatus for the pixel by pixel printing of digital image information onto a planar picture carrier in a printing device by way of a movable printing head.

### BACKGROUND ART

The manufacture of physical prints of digital originals is increasingly carried out by a printing process, whereby inkjet printers are normally used. A high-performance inkjet printer which is typically used for these purposes is known.

Borderless pictures are often desired by the photographic industry. However, when inkjet printers are used, this is associated with problems to which a satisfactory solution has not yet been found. In an often applied method for the manufacture of borderless pictures, a picture format to be printed is selected which is smaller than the picture carrier format, so that pictures with an unprinted border are produced, and the unprinted borders are cut off. This method requires relatively expensive cutting operations and additionally produces undesired picture carrier waste. In another common method, the picture format to be printed is selected larger than the picture carrier format. However, this wastes printing ink and furthermore, there is a danger of soiling by the printing inks applied outside the picture carrier, and the removal of the printing inks applied outside the picture carrier is relatively expensive.

It is a further danger with inkjet printers the individual nozzles of the printing heads may clog. Although it is possible to maintain the printing nozzles clear and thereby functional by frequent flushing or other cleaning, this results in a relatively high printing ink consumption. Furthermore, the printing heads become prematurely worn by the frequent cleaning and the printing process must be interrupted relatively frequently. It is also known to print special test patterns from time to time, by way of which it can be determined visually or by photoelectric scanning and analysis of the scanning signals whether and, if desired, which printing nozzles have failed.

A visual inspection is unsuited for high-performance printers, because of the danger of producing large amounts of waste. The known automatic systems with photoelectric scanning are only adapted for relatively large print dots (ink droplets) and for a relatively small number of inkjets and are therefore not suited for modern high-performance printers with very high-resolution and a correspondingly large number of very fine ink nozzles.

High-performance inkjet printers include a plurality of print heads, which must be exactly mutually oriented in a costly manner, since incorrect adjustments lead to visible disturbances in the printed image. Visible disturbances are further caused by incorrect location of printing dots from individual printing nozzles and by different sizes of printing dots from individual printing nozzles. Although the latter can be averaged out (corrected or compensated for) to some degree by multiple printing passes, that significantly reduces the printing speed.

A further problem of inkjet printers is to correct color reproduction, which is subject to variations due to changes in the picture carrier material, the printing inks, the printing head characteristics and environmental conditions such as temperature and humidity. Although an exact color reproduction can be achieved by limiting the number of picture carrier materials used (printing media, printing substrates) and by carefully profiling each combination of printing modes and picture carrier materials, this is achieved at the cost lost flexibility with respect to the usable picture carrier materials and printing inks. When a new picture carrier material is added, a new profile must first be created at additional expense and by employing specially trained personnel.

It is now a primary object of the present invention to solve the problem of manufacturing borderless pictures in a simple and economic manner. A waste of picture carrier material and printing ink is thereby to be particularly avoided. It is a further object of the invention to combine the solution of the problem for the manufacture of borderless pictures with the provision of the prerequisites for getting the other above mentioned difficulties with inkjet and comparable printers under control.

This object of the invention is achieved by the printing process in accordance with the invention, wherein the borders of the picture carrier are detected, preferably by way of a photoelectric sensor, and the printing of the pixels of the digital picture which lie beyond the borders of the picture carrier is suppressed. When the borders are detected with sufficient precision, a borderless printing is possible in this manner without wasting printing ink. It is thereby understood, that the format of the picture to be printed should be selected marginally larger than the format of the picture carrier.

When the photoelectric sensor is suitably constructed, it can also be used for the photoelectric scanning or measurement of co-printed print head test patterns, in accordance with a further aspect of the invention. The functional condition of the print head or print heads of the printing apparatus can then be determined by analyzing with suitable algorithms the measured data produced by the sensor, and corresponding measures can then be initiated. The production of waste can be reliably prevented in this manner.

When the photoelectric sensor is adapted for densiometric or colorimetric measurement tasks, it can also be used for the measuring of co-printed color test patterns, according to a further aspect of the invention. In this manner, changes in the color reproduction quality can be recognized in time by measurement technology and corrected by suitable measures.

The most basic and general idea of the present invention consists in the use of a single, specially constructed multifunctional sensor for a series of very different photoelectric measurement tasks. All the above described problems with inkjet printers and comparable printers can be addressed in a simple manner by way of this special multifunctional sensor (and a corresponding control or analysis arrangement for the measured data produced by the sensor).

### BRIEF DESCRIPTION OF THE DRAWINGS

The invention will be described in the following with reference to the drawings, wherein

FIG. 1 shows a principle schematic of the preferred embodiment of the printing device in accordance with the invention;

FIG. 2 shows an exemplary embodiment of a photoelectric multifunctional sensor provided in the printing device in accordance with the invention;

FIG. 2a is a schematic view of the inspection region of the sensor shown in FIG. 2;

FIG. 3 is a schematic illustration of the progression of the position of the borders of a picture carrier;

FIG. 4 is a function sketch for the illustration of the detection of the borders of the picture carrier;

FIG. 5 is a schematic illustration of a mask;

FIG. 6 is a schematic illustration of masked image information;

FIGS. 7 to 9 show typical test patterns for control of the functional condition of the printing heads and the color reproduction quality; and

FIGS. 10 to 12 show the typical measured data diagrams belonging to the situations shown in FIGS. 7 to 9.

### DETAILED DESCRIPTION OF THE PREFERRED EMBODIMENT

The printing apparatus referred to in FIG. 4 in its entirety as P includes in a housing or frame (not illustrated) an ink jet printing unit HU which normally consists of several inkjet print heads H, which are fed by not illustrated reservoirs for printing inks of different colors. Further provided in the housing are positioning means 1, illustrated only symbolically by a double arrow, for a sheet or web shaped picture carrier M to be printed (normally paper of suitable quality). The positioning means provide for the displacement of the picture carrier M in or through the printing device P in a defined matter along a displacement path 1a relative to the printing unit HU or relative to the print heads H, whereby a control C controls the movements in a manner generally known. Furthermore, advancing means 2 controlled by the control C, which are also only symbolically indicated by a double arrow, are provided in the printing device P, by which the printing head unit HU or the print heads H are adjustable along a displacement path 2a extending essentially transverse to the path of moment 1a of the picture carrier.

The picture carrier M and the printing heads H are thereby movable relative to one another in a generally known manner in two orthogonal directions, so that each print head H can be positioned under the control of the control C at any desired location of the picture carrier M. The print heads H of the printing head unit HU are controlled by the control C and print on the picture carrier M the digital image information I wish was fed to the control C by an external computer or like. The image information I is printed pixel by pixel onto the picture carrier M in a manner generally known and in the form of fine ink droplets.

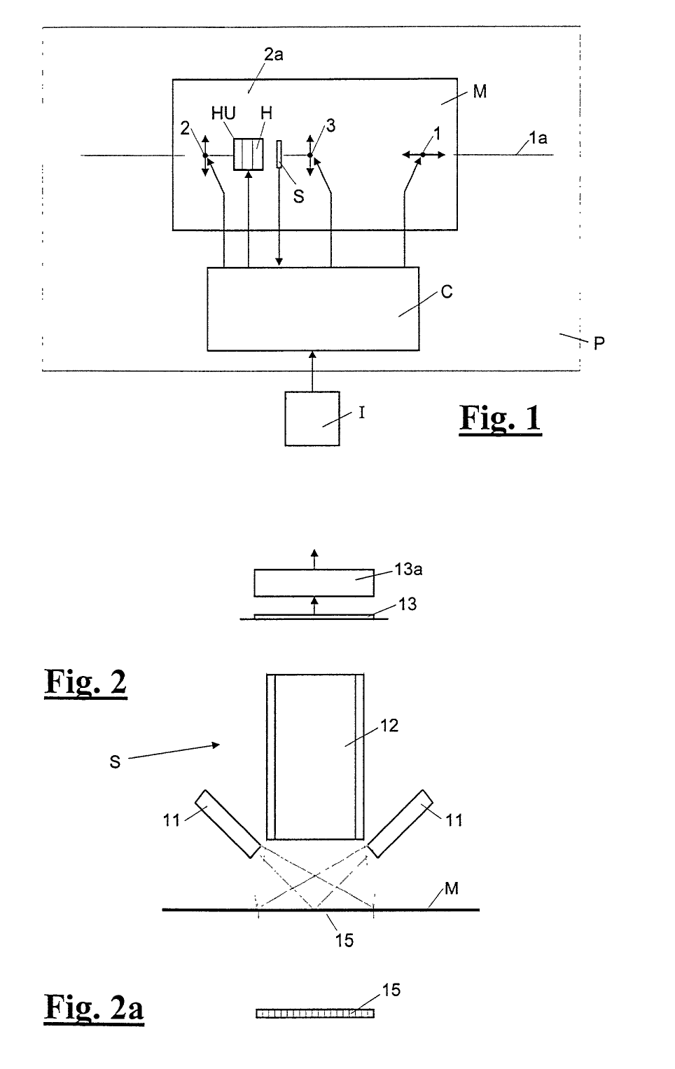

In the practical embodiment, the printing device can be constructed, for example, as a drum recorder as described in all detail in EP-A 1 009 158. Such a drum recorder typically includes a rotating clamping drum for the recording medium (the picture carrier) and a printing unit which is stationary relative to the rotational movement of the clamping drum, which consists of 1 or more print heads displaceable parallel to the axis. The whole surface of the image carrier held on the clamping drum is passed over by rotation of the clamping drum on the one hand and displacement of the printing heads parallel to the axis of the tensioning drum on the other hand. The rotational or circumferential direction of the tensioning drum corresponds to the displacement path 1a in FIG. 1 and the direction of the clamping drum axis corresponds to the displacement track 2a in FIG. 1.

Up to this point, the printing apparatus in accordance with the invention fully and wholly corresponds to conventional inkjet printing devices and, therefore, does not require any further explanation for the person skilled in the art.

According to the most preferred aspect of the present invention, the printing device is equipped with a photoelectric multifunctional sensor S which can be moved back and forth parallel to the print heads H over the whole width of the picture carrier M by way of a drive means 3 also controlled by the control C and only symbolically identified by a double arrow. Alternatively, the sensor S can also be mechanically connected with the print head unit HU and positioned for movement therewith. The sensor S photoelectrically scans the picture carrier M positioned thereunder, whereby the scanning signals produced by the sensor S are processed by the control C in a manner which will be described later and analyzed for the process in accordance with the invention.

The principal construction of the photoelectric sensor S is apparent from FIG. 2. It is constructed as a color enabled remissions sensor of high local resolution and includes essentially a light source in the form of several light emitting diodes 11, a capturing optics 12, and a photoelectric converter 13, which itself is made of a linear or two-dimensional field of photoelectric converter elements. The light source exposes, or the light emitting diodes 11 expose the picture carrier M under the sensor S to measuring light essentially at an angle of 45°.

The measuring light remitted from the surface of the picture carrier M is captured by the capturing optics 12 under 90° and directed onto the photoelectric converter 13, which converts it into corresponding electric signals.

For improvement of the contrast, the light emitting diodes 11 preferably emit the colors complementary to the printing inks used, i.e. typically red, blue or green. Instead of the colored light emitting diodes, sources of white light can be provided in combination with suitable color filters.

The capturing optics 12 is preferably formed by a field of gradient-index glass fibers, but can also be realized as a conventional object lens.

The photoelectric converter 13 is preferably realized in CCD or CMOS technology and has a relatively high linear resolution of, for example 10μ. The length of the converter can be, for example, 20-30 mm, which corresponds to a number of 2000 to 3000 converter elements [pixels] per line. The converter 13 can include one or more lines of converter elements and is connected to the control C by way of a driver electronic 13a. The electric signals produced by the individual converter elements and corresponding to the measuring light received are transmitted in a known manner by the driver electronic 13a to the control C.

Color enabled photoelectric scanning devices (sensors) which operate pixel by pixel with photoelectric converter elements fields (CCD arrays and the like) as well as the driver electronics and signal processors required therefor are known in the color measuring technology from digital cameras and therefore do not require any further explanation for the person skilled in the art.

The capturing optics 12 and the converter 13 can be realized as an analog or digital camera, for example, which already includes the driver and signal processing electronic 13a for the photoelectric converter elements.

The sensor S photoelectrically scans the picture carrier pixel by pixel respectively in a narrow, rectangular inspection region with high local resolution, whereby densiometric color measurements are also possible with the use of colored measuring light. Such an inspection region is illustrated in FIG. 2a and referred to by reference number 15. The length of a typical inspection region is about 20-30 mm, the width about 10 μ to several mm. The linear local resolution in longitudinal direction is typically about 10 μ. Of course, the dimensions of the inspection region can also be differently selected without departing from the framework of the present invention.

In the normal case, the sensor S is oriented such that the longitudinal extent of the inspection region 15 is parallel to the displacement path of the print heads H or the sensor S itself. However, the sensor S can also be positioned in such a way that the longer side of the inspection region 15 is rotated an angle of preferably 45° to the displacement path of the print heads H.

Because of its special construction according to the invention, the sensor S can be used for all required measurement tasks, in order to solve the above mentioned problems with inkjet printers during printing.

According to a first aspect of the invention, the sensor is used for capturing the exact local progression of the borders of the picture carrier M. The information obtained on the location of the borders is thereby used for blocking out of the image elements (pixels) of the digital image information I to be printed which are located beyond the borders, so that image elements which are located outside the borders are not printed. This is further described in the following, whereby it is assumed for reasons of simplicity that the picture carrier M is in the form of any web material so that generally only the two opposite lateral borders of the picture carrier need be detected. The case of picture carriers in sheet form or the capturing of borders extending transverse to the direction of movement of the picture carrier M is dealt with further below.

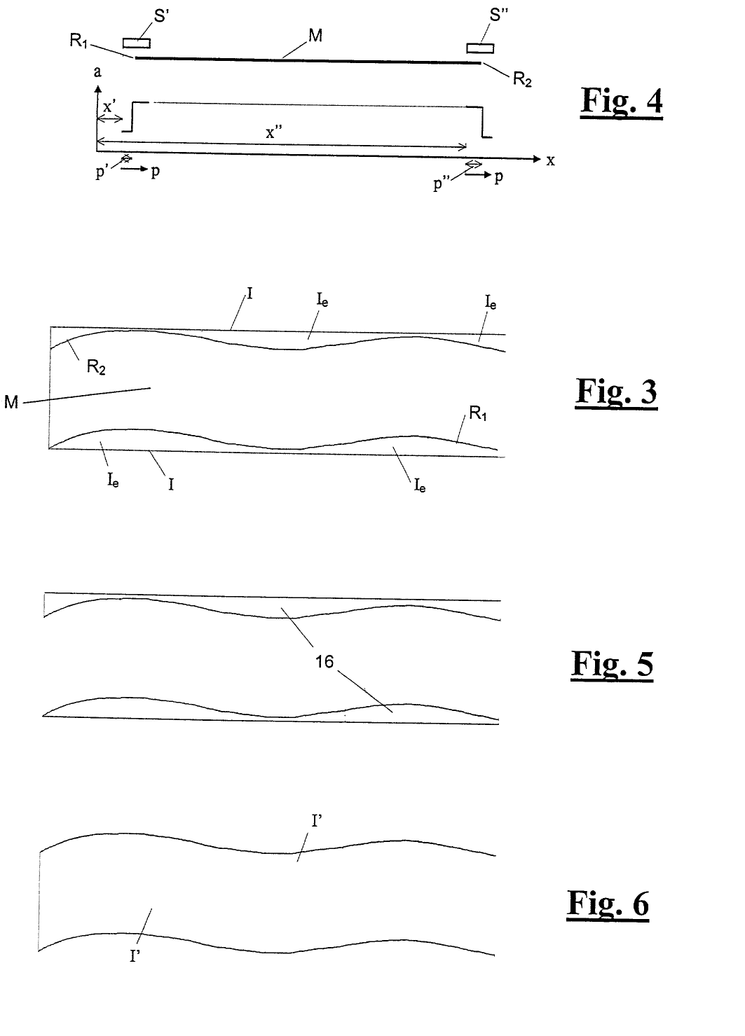

As illustrated strongly exaggerated in FIG. 3, the location of the lateral borders R1 and R2 of the picture carrier M varies within certain limits relative to a stationary coordinate system in the printing device, for example, because inexactness of the positioning means 1 which are hard to prevent in practice and possibly also because of variations in the width of the picture carrier itself. Since the movement of the print heads and therefore the location of the printed picture is also with respect to this stationary coordinate system, more or less large marginal regions of the image information or images I to be printed as identified by rectangles come to lie outside the picture carrier M. The image regions lying outside the borders of the picture carrier M are identified as Ie in FIG. 3. In order to be able to eliminate in accordance with the invention these picture regions Ie, or the pixels forming them, which means being able to suppress these picture elements, the local position of the two lateral borders R1 and R2 of the picture carrier must be known at each point along the longitudinal extent of the picture carrier.

FIG. 4 schematically illustrates how the capturing of the location of the lateral borders of the image carrier M takes place in principle by way of the sensor S. One coordinate axis of the already mentioned stationary coordinate system which extends parallel to the direction of movement 2a of the sensor is called x, the axis a defines the level or signal strength of the electric signals produced by the individual converter elements of the sensor S, and corresponding to the intensity of the measuring light impinging thereon. The two coordinate axes p define the relative location (pixel coordinates) of the individual converter elements of the sensor thereon.

The sensor is transversely moved by the control C across the width of the picture carrier M into two positions indicated S′ and S″ in FIG. 4 having the local coordinates x′ and x″, in which it or the inspection region captured by it is located over the borders R1 and R2 of the picture carrier M. At those positions, the converter elements receiving measuring light from within regions inward from the border of the picture carrier M deliver a high signal level, while the remaining converter elements do not receive measuring light and therefore produce a low signal level. The converter elements which fall within the level changes are determined by the control C by suitable analysis of the measurement signals and their relative locations p′ and p″(pixel coordinates) on the sensor are determined. The pixel coordinates p′ and p″ together with the location coordinates x′ and x″ of the sensor provide the exact positions of the two borders R1 and R2 of the picture carrier M. The picture carrier M is now advanced by a path increment in direction of the displacement path 1a and the whole process repeated until the local progression of the two borders has been captured over the whole length of the image carrier M.

An alternative approach consists in that first the complete local progression of only one border R1 is captured and subsequently the path of the other border R2. This approach is advantageous especially when the printing device P is constructed as a drum recorder according to EP-A 1 009 158. The sensor is thereby first positioned over one border of the image carrier fastened to the clamping drum and then the clamping drum rotated once through 360°. Subsequently, the sensor is positioned over the other border and the tensioning drum is again rotated through 360°. During each rotation of the clamping drum, the local position of respectively one of the two lateral borders along the whole fastened image carrier is determined and stored.

By way of the stored local progression of the borders of the image carrier M, a mask is calculated in the control C and positioned over the image information I to be printed. The mask identifies all those pixels Ic of the image information I to be printed, which are located outside the previously captured borders R1 and R2 of the picture carrier M. Superposing the mask over the image information I is carried out in a way so that the digital color values of the affected pixels Ic are set at “transparent” so that those pixels Ic are not printed. Such a mask is schematically illustrated in FIG. 5 and referred to as 16. FIG. 6 schematically illustrates the printable image information I′ remaining after superposition of the image information I with the mask 16.

The above described approaches capture the borders of the image carrier M before the printing of the image information I. This presumes that the image carrier M can be reproducably positioned to in the printing device with sufficient precision. If this is not possible due to the construction of the printing device, the capturing of the borders and the calculation and superposition of the mask must be carried out “on-the-fly” line by line during the printing operation. The local position of one border of the image carrier M is thereby captured for each printing line defined by the transverse movement of the print heads H along the displacement path 2a and the position of the picture carrier M along the displacement path 1a, and a partial mask is calculated therefrom and superposed onto the image information I (for this printing line), so that pixels (of this printing line) which are located outside of this border not printed. The print heads H together with the sensor S are then advanced normally and the line of image information is printed. As soon as the opposite border of the image carrier enters the inspection region of the sensor S, the local position of this opposite border is captured and a second partial mask calculated therefrom and superposed onto the image information (of this printing line) so that the pixels (of this printing line) which are located outside this border are also not printed. The process is subsequently repeated in the opposite direction and so on until the whole image information is printed.

As already mentioned, borders extending transverse to the advancement direction 1a of the picture carrier M can also be captured with the sensor S. In the normal orientation of the sensor S orthogonally to the advancement direction la, the signal levels of practically all converter elements of the sensor S simultaneously change during passage over a transversely extending border. The local position of the respective border can be determined from the temporal or three-dimensional information of this level change and the mask calculated therefrom (in combination with the location information of the two lateral borders). Analog to the capturing of the two lateral borders, the preceding and subsequent borders of the picture carrier can also be captured “on-the-fly”, when a capturing before printing is not possible, for example, because of the mechanical parameters of the printing device. When the sensor S is positioned rotated relative to the displacement path 2a of the print heads H at a specific angle, especially 45°, the capturing of the preceding or following borders can be carried out similar to the manner described in connection with FIG. 4.

Of course, the control C can also be constructed to interrupt the printing process or not even start it and to output a corresponding warning, if the captured borders of the picture carrier are located outside a preselected tolerance range.

According to a second aspect of the present invention, the sensor S is also used for the measurement of from time to time (co-)printed test patterns, by way of which the functional condition and the mutual adjustment of the print heads H can be automatically tested.

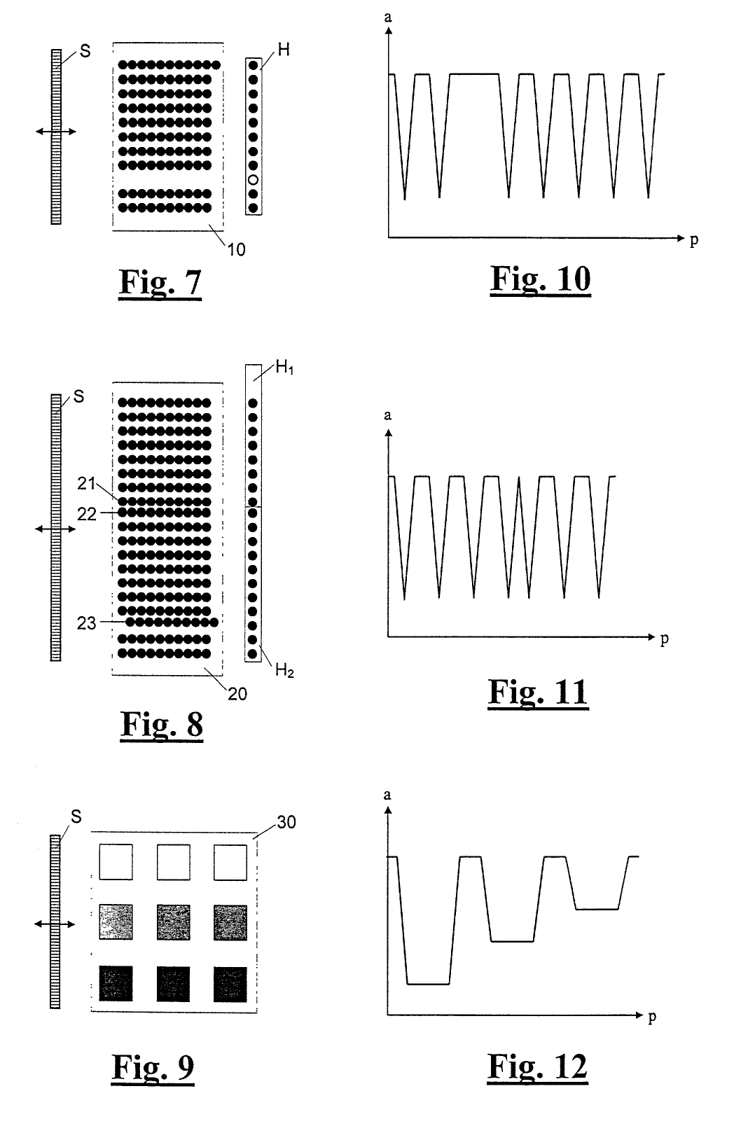

FIGS. 7-10 schematically describe the approach for the recognition of print nozzles of the print heads H which have failed, for example, because of clogging. A test pattern 10 is printed therefor, which is created by single or multiple activation of all nozzles of one color of respectively one print head H during advancement of the picture carrier. Each functioning nozzle thereby prints a short line, while missing lines are caused by clogged nozzles. To prevent ambiguities during this scanning, at least one of the lines of the test pattern is longer (or shorter) than the others. In contrast to those test patterns used for visual inspection, the test pattern 10 can be maintained very small and therefore can be positioned between the pictures to be printed or close to the border of the picture carrier.

The test pattern 10 is singly or multiply scanned with the sensor S transverse to the lines of the test pattern. During each scanning, the typical signal trace as partially illustrated in FIG. 10 is created by way of the individual converter elements (pixel coordinate p) of the sensor S. Each line of the test pattern 10 actually present creates a negative signal peak, while the corresponding signal peak is missing when the line is missing because of nozzle failure. The control C can determine from the signal trace by counting of the peaks and identification of the missing peaks whether and possibly which nozzles of the respective printing head H have failed. When the failure of one or more printing nozzles has been recognized in this way, it is automatically decided by way of a preselected criterion, whether the printing process must be interrupted and maintenance (cleaning, replacement) of the print head requested or initiated or whether the printing process can be continued with the remaining functional printing nozzles. Because, when not too many printing nozzles have failed, it is possible to divide the tasks of the failed nozzles over the remaining functional nozzles in a known manner. This approach is generally known as software nozzle replacement. The cleaning of the print heads H can also be carried out, possibly with the help of known cleaning agents and methods, under the control of the control C.

FIGS. 8 and 11 schematically illustrate the procedure for the testing of the mutual adjustment of the print heads upon detection of incorrect locations of printed dots of individual print nozzles. A test pattern 20 is printed which is structured similar to the test pattern 10 but with the distinction that it is printed with more than one print head H (H1 and H2 in the illustrated example). As is apparent, in this example the two printing heads H1 and H2 are incorrectly adjusted, since the two lines 21 and 22 of the test pattern 20 are too close to one another. Furthermore, one of the nozzles of the print head H2 produces an incorrect positioning for the print dots produced thereby (line 23). The typical signal trace over the pixel coordinate p generated upon scanning of the test pattern 20 is illustrated in FIG. 11 (partially). The control C again analyzes these signal traces. Thereby not only the number of lines present his determined, but also their relative positions (pixel coordinate). The positions of the individual lines are compared with preset positions. Upon the occurrence of deviations, is automatically decided whether or not a correction measure is required. The correction measure can consist on the one hand in a mechanical readjustment of the print heads H or in the use of a software correction, which can compensate for the incorrect adjustment of the printing heads and also the incorrect locations of the printing dots produced by the nozzles. The mechanical readjustment of the printing heads H can possibly also be carried out automatically by the control C by way of adjustment means. The adjustment means can be, for example, motor driven set screws or other actuators for the adjustment of the print heads.

According to a further aspect of the present invention, the sensor S is also used for the measuring of color test patterns, by way of which the color reproduction quality of the print device can be tested and corrected if necessary. FIGS. 9 and 12 schematically illustrate the approach required therefor.

A color test pattern 30 is printed, which consists of a number of (9 in the illustrated example) small color test fields of different colors. Typically, the colors of the printing inks used (cyan, yellow, magenta, black) and the edited primary colors (red, blue, green) as well as black and some gray shades are used. The color measurement fields of the color test pattern are scanned with the sensor S, whereby each color measurement fields is measured with each measurement light color. FIG. 12 shows a typical signal trace over the pixel coordinate p for one scanning passage (three captured color measurement fields with one measurement light color). The intensity values determined for the individual color measurement fields for each measurement light color are compared to reference values previously stored in the control C and the deviations determined. When the deviations fall outside a preselected tolerance range, a correction measure is initiated.

A suitable correction measure can be, for example, the adjustment or new generation of the apparatus profile of the printing device P (printer output profile) and the subsequent carrying out of all printing processes with the new profile. Methods and apparatus for the generation of apparatus profiles are described in the color management literature and are known to the person skilled in the art.

An alternative possibility for an automatic correction measure consists in influencing the size of the ink droplets produced by the nozzles of the print heads H by corresponding adjustment of the driver voltages applied to the nozzles. By changing the droplet sizes, the color reproduction characteristic of the printing device can be automatically controlled within certain limits.

It is required for this approach that the color test pattern 30 include halftone color test fields in the pure colors of the colored inks used, i.e. color test fields in the colors of the printing inks with a respective area coverage of less than 100 percent. These halftone color test fields are measured in the manner described by way of the sensor S and their color densities are determined and compared with reference values. When the color density measured for a printing ink falls outside a preselected tolerance range, the droplet size for this color ink is, depending on the deviations, increased or reduced by way of the control C. In this manner, the color reproduction quality of the printing device can be automatically maintained constant within certain limits.

1. A process for the pixel-by-pixel printing of digital image information on a planar picture carrier, comprising the steps of
positioning the picture carrier into a printing device including at least one print head movable relative to the picture carrier for placing at least one color compound pixel-by-pixel onto the picture carrier;
detecting the position of two opposite borders of the picture carrier by means of a sensor; and
suppressing the printing of pixels of the image information which are located outside the borders detected.

2. The process of claim 1, wherein the picture carrier is a sheet material and the position of all four borders of the picture carrier are captured.

3. The process of claim 1, wherein the picture carrier is a strip-shaped material and only the position of the lateral borders of the picture carrier is captured.

4. The process of claim 1, wherein the step of detecting the position of the borders of the picture carrier is carried out prior to printing of the image information.

5. The process of claim 1, wherein the step of detecting the position of the borders of the picture carrier is carried out during printing of the image information.

6. The process of claim 1, comprising the further steps of
printing a print head test pattern;
measuring the test pattern by way of a sensor to obtain measurement data;
determining the functional condition of the at least one print head from the measurement data and comparing the functional condition with a preset condition; and, upon a deviation of the functional condition from the preset condition,
at least one step selected from the group of automatically initiating a corrective measure, producing a status report, and aborting the printing process.

7. The process of claim 6, wherein the step of initiating a corrective measure includes an automatic cleaning of the print head.

8. The process of claim 6, including the further step of upon failure of individual functional elements of the print head transferring the tasks thereof to the remaining functioning functional elements so that the complete image information is printed with the remaining functioning functional elements.

9. The process of claim 1, comprising the further step of printing at least one color test pattern;
measuring the test pattern with a sensor to obtain color measurement data;
comparing the color measurement data with preset reference values; and
upon exceeding of a preselected threshold of deviation of the color measurement data from the reference values, carrying out at least one step selected from the group of automatically initiating a corrective measure, producing a status report, and aborting the printing process.

10. The process of claim 9, wherein the corrective measure is the step of adjusting the droplet size of the color compound.

11. The process of claim 9, wherein the corrective measure is the step of adjusting a profile of the printing device.

12. The process according to claim 1, wherein the sensor used is a photoelectric remission sensor which includes a multicolored light source for exposing the picture carrier with measuring light, a capturing optics for the measuring light remitted by the picture carrier, and a photoelectric converter in the form of a linear or two-dimensional field of optoelectric converter elements.

13. Apparatus for the pixel-by-pixel printing of digital image information on a planar picture carrier, comprising
positioning means for positioning the picture carrier;
at least one print head movable relative to the picture carrier for placing at least one color compound pixel-by-pixel onto the picture carrier;
a control for the positioning means and the at least one print head;
a sensor cooperating with the control for detecting the position of at least two opposite borders of the picture carrier; and
whereby the control is constructed for suppressing the printing of pixels of the image information which are located outside the borders detected.

14. The apparatus of claim 13, wherein the control is constructed for detecting the position of the borders of the picture carrier prior to the printing of the image information.

15. The apparatus of claim 13, wherein the control is constructed for detecting the position of the borders of the picture carrier during the printing of the image information.

16. The apparatus of claim 13, wherein the control is constructed for the printing at least from time to time of a print head test pattern; for the measuring of the test pattern by way of the sensor to obtain measurement data, for determining the functional condition of the at least one print head from the measurement data and comparing the functional condition with a preset condition; and upon a deviation of the functional condition from the preset condition, for carrying out at least one step selected from the group of automatically initiating a corrective measure, producing a status report, and aborting the printing process.

17. The apparatus of claim 16, including multiple print heads and further including adjustment means cooperating with the control for adjusting a mutual positioning of the print heads, the control being constructed for carrying out together with the adjustment means an adjustment of the mutual positioning of the print heads as the corrective measure.

18. The apparatus of claim 16 or 17, further comprising means cooperating with the control for the automatic cleaning of the print head.

19. The apparatus of claim 16 or 17, wherein the control is constructed for, upon failure of individual functional elements of the print head, transferring the tasks thereof to the remaining functioning functional elements so that the complete image information is printed with the remaining functioning functional elements.

20. The apparatus of claim 16 or 17, wherein the control is constructed for compensating deviations in size and position of the image elements by controlling the adjacent image elements.

21. The apparatus of claim 13, wherein the control is constructed for printing at least one color test pattern, for measuring the test pattern by way of the sensor to obtain color measurement data, for comparing the color measurement data with preset reference values; and for carrying out, upon exceeding of a preselected threshold of deviation of the color measurement data from the reference values, at least one action selected from the group of automatically initiating a corrective measure, producing a status report, and aborting the printing process.

22. The apparatus of claim 21, wherein the control is constructed to carry out as corrective measure an adjustment of the droplet size of the color compound.

23. The apparatus of claim 9, wherein the control is constructed to carry out as corrective measure an adjustment of a profile of the printing device.

24. The apparatus of claim 13, wherein the sensor is a photoelectric remission sensor which includes a multicolored light source for exposing the picture carrier with measuring light, a capturing optics for the measuring light remitted by the picture carrier, and a photoelectric converter in the form of a linear or two-dimensional field of optoelectric converter elements.

25. The apparatus of claim 24, wherein the multi colored light source is formed by light emitting diodes radiating colors which are complementary to the color compounds used.

26. Apparatus for the pixel-by-pixel printing of digital image information on a planar picture carrier, comprising
positioning means for positioning the picture carrier;
at least one print head movable relative to the picture carrier for placing at least one color compound pixel-by-pixel onto the picture carrier;
a control for the positioning means and the at least one print head;
a color enabled photoelectric sensor cooperating with the control which is constructed for detecting the position of at least two opposite borders of the picture carrier and also the measurement of print head test patterns and color test patterns.

27. The apparatus of claim 26, wherein the sensor is a photoelectric remission sensor which includes a multicolored light source for exposing the picture carrier with measuring light, a capturing optics for the measuring light remitted by the picture carrier, and includes a photoelectric converter in the form of a linear or two-dimensional field of optoelectric converter elements.

28. The apparatus of claim 26 or 27, further comprising drive means for moving the sensor relative to the picture carrier.

29. The apparatus of claim 26 or 27, wherein the sensor is mechanically coupled with the at least one print head and movable therewith.
